(19) United States
(12) Patent Application Publication
(10) Pub. No.: US 2026/0080558 A1
(43) Pub. Date: Mar. 19, 2026

(54) DRIVE-THROUGH SERVICE MONITORING SYSTEM AND METHOD

(71) Applicant: Hendricks Corp. Pte. Ltd., Singapore (SG)

(72) Inventors: Wai Meng Chan, Singapore (SG); Michael Tjia, Singapore (SG); Xue Ting Lim, Singapore (SG); Jun Ren Tan, Singapore (SG); Lu Xian Sascha Brueschweiler, Singapore (SG); Souhail Meftah, Singapore (SG); Ricky Sanjaya, Singapore (SG); Kin Sun Wong, Singapore (SG); Yilin Jia, Singapore (SG); Jinwen Zhu, Singapore (SG)

(73) Assignee: Hendricks Corp. Pte. Ltd., Singapore (SG)

(21) Appl. No.: 18/920,648

(22) Filed: Oct. 18, 2024

(30) Foreign Application Priority Data
Sep. 13, 2024 (AU) 2024219697

(51) Int. Cl. G06T 7/70; G01S 15/04; G01S 15/88; G06Q 50/12; G06V 20/52; G06V 20/62; G06V 40/10

(52) U.S. Cl. CPC G06T 7/70; G01S 15/04; G01S 15/88; G06Q 50/12; G06V 20/52; G06V 20/625; G06V 40/10; G06T 2207/30196; G06T 2207/30232; G06T 2207/30252; G06V 2201/08

(57) ABSTRACT

A drive-through service monitoring system comprising: a camera provided at each of a plurality of locations in a drive-through service to obtain real-time footage of vehicles at each of the plurality of locations; and an intelligent video analytics (IVA) system provided and configured to determine, from the real-time footage obtained by the cameras: vehicle licence plate numbers to identify each vehicle at each of the plurality of locations and variables associated with vehicles using the drive-through service, wherein the variables include: a dwell time of each identified vehicle at each of a number of predetermined locations in the plurality of locations; and for each identified vehicle, at least one duration between at least one distinct pair of locations in the plurality of locations.

### TECHNICAL FIELD

The present disclosure relates to a system and method for monitoring a drive-through service.

### BACKGROUND

Drive-through services provided by establishments such as quick service restaurants allow customers to purchase products or services while remaining in their vehicles. In a simple example of a drive-through service, the customer typically stops the vehicle at an ordering point to place an order. After placing the order, the vehicle is moved to a collection point where the vehicle is stopped to wait for the ordered items before leaving the drive-through service.

In conventional drive-through services, to detect presence of a vehicle at the ordering point (in order to trigger commencement of the ordering process), a vehicle detection magnetic loop comprising a coil of insulated wire is provided in the roadway at the ordering point where the vehicle would pass directly over it. To install the magnetic loop, slots must be cut into the roadway using a masonry cutter. The insulated wire is then disposed in the slot and the slot filled with bitumen or epoxy to prevent entry of water and to immobilise the wire. Another way of installing the magnetic loop involves burying the insulated wire in wet concrete at the time of pouring during construction of the roadway. Ends of the magnetic loop are then electrically connected to a vehicle detector electronic module that energises the magnetic loop to give rise to a magnetic field around the loop wire. When a vehicle passes over the magnetic loop, a change in the magnetic field is detected by the electronic module to indicate presence of the vehicle.

Appreciably, installing magnetic loops for drive-through services involves significant cost and construction downtime. The costs and time involved can be substantial for larger drive-through services or chain establishments that have multiple drive-through service locations that require installation of multiple magnetic loops.

### SUMMARY

According to a first exemplary aspect, there is provided a drive-through service monitoring system comprising: a camera provided at each of a plurality of locations in a drive-through service to obtain real-time footage of vehicles at each of the plurality of locations; and an intelligent video analytics (IVA) system provided and configured to determine, from the real-time footage obtained by the cameras: vehicle licence plate numbers to identify each vehicle at each of the plurality of locations and variables associated with vehicles using the drive-through service, wherein the variables include: a dwell time of each identified vehicle at each of a number of predetermined locations in the plurality of locations; and for each identified vehicle, at least one duration between at least one distinct pair of locations in the plurality of locations.

The IVA system may be further configured to determine, from the real-time footage obtained by the cameras, whether a person appearing in the real-time footage is a service crew member of the drive-through service, and wherein the variables further include: a specific time when ordered items are received by an identified vehicle at the wait bay from a service crew member, and a duration between the specific time when the identified vehicle is moved to the wait bay and the specific time when the ordered items are received by the identified vehicle at the wait bay from the service crew member.

The IVA system may further comprise a data visualization module configured to present the determined variables and target variables on a dashboard displayed on an electronic visual display.

The IVA system may be further configured to trigger an alert when a preselected variable is determined to cross a preset threshold.

An ultrasonic sensor may be provided at each location in the drive-through service that requires establishment of remote communication between a customer at the location and a service crew member who is located elsewhere in the drive-through service to detect arrival of a vehicle at the location and consequently automatically activate a voice communication system provided at the location so that the customer and the service crew member located elsewhere can immediately talk to each other without having to manually activate the voice communication system.

According to a second exemplary aspect, there is provided a method of monitoring a drive-through service, the method comprising: obtaining real-time footage of vehicles at each of a plurality of locations in the drive-through service using a camera provided at each of the plurality of locations; and using an IVA system, from the real-time footage obtained by the cameras: determining vehicle licence plate numbers to identify each vehicle at each of the plurality of locations and determining variables associated with vehicles using the drive-through service, wherein the variables include: a dwell time of each identified vehicle at each of a number of predetermined locations in the plurality of locations; and for each identified vehicle, at least one duration between at least one distinct pair of locations in the plurality of locations.

The method may further comprise, using the IVA system, from the real-time footage obtained by the cameras, determining at least one of: a specific time when an identified vehicle is moved to the wait bay, percentage of vehicles moved to the wait bay, a number of vehicles in the drive-through service between the entry and a final collection point, and a number of vehicles exiting the drive-through service before reaching the ordering point.

The method may further comprise, using the IVA system, from the real-time footage obtained by the cameras, determining whether a person appearing in the real-time footage is a service crew member of the drive-through service, determining a specific time when ordered items are received by an identified vehicle at the wait bay from a service crew member, and determining a duration between the specific time when the identified vehicle is moved to the wait bay and the specific time when the ordered items are received by the identified vehicle at the wait bay from the service crew member.

The method may further comprise a data visualization module of the IVA system presenting the determined variables and target variables on a dashboard displayed on an electronic visual display.

The method may further comprise the IVA system triggering an alert when a preselected variable is determined to cross a preset threshold.

The method may further comprise providing an ultrasonic sensor at each location in the drive-through service that requires establishment of remote communication between a customer at the location and a service crew member who is located elsewhere in the drive-through service, and, using the ultrasonic sensor, detecting arrival of a vehicle at the location and consequently automatically activating a voice communication system provided at the location so that the customer and the service crew member located elsewhere can immediately talk to each other without having to manually activate the voice communication system.

For both aspects, each distinct pair of locations may comprise a first location and a second location, and wherein the duration is at least one of: from arrival at the first location to arrival at the second location, from arrival at the first location to departure from the second location, from departure from the first location to arrival at the second location, and from departure from the first location to departure from the second location.

For each distinct pair of locations, the second location may be the collection point and the first location may be one of: the ordering point and an entry of the drive-through service.

The plurality of locations may include an ordering point where customers place their orders and a collection point where ordered items are received; and wherein the predetermined locations include at least one of: the ordering point and the collection point.

The collection point may be at least one of: a payment point where payment is made for an order placed at the ordering point, a pull forward area provided after the payment point, and a wait bay provided after the pull forward area.

The variables may further include at least one of: a specific time when an identified vehicle is moved to the wait bay, percentage of vehicles moved to the wait bay, a number of vehicles in the drive-through service between the entry and a final collection point, and a number of vehicles exiting the drive-through service before reaching the ordering point.

The variables may further include an average dwell time from the dwell times determined for multiple identified vehicles at each of the predetermined locations, and average durations from the durations determined between distinct pairs of locations for the multiple identified vehicles.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

FIG. 1 is a schematic illustration of a drive-through service provided with a drive-through service monitoring system.

FIG. 2 is a schematic exemplary architectural diagram of the drive-through service monitoring system.

FIG. 3 is a screenshot of an exemplary dashboard in table form of the drive-through service monitoring system showing real-time information on vehicle dwell times at various locations, vehicle ordering completion to pick up and exit times, completion of service crew delivery at wait bays, and also showing target durations and average durations from the past hour at various locations of the drive-through service.

FIG. 4 is a screenshot of an exemplary dashboard showing target dwell times and average dwell times in pie chart form.

FIG. 5 is a screenshot of an exemplary dashboard in pie chart form showing drive-through metrics such as number of vehicles that completed using the drive-through service in the last N minutes (Capacity), number of vehicles currently in drive-through lanes (Cars in Lane), number of vehicles leaving the drive-through service before placing an order (Pull Outs), percentage of vehicles parked at waiting bay in the last N minutes (Park %), and number of vehicles that completed using the drive-through service in the last hour/daily (Car Count) in table form, as well as target ordering completion to pick up and exit time (OEPE), target total experience time (TET), and their respective average durations.

FIG. 6 is a screenshot of an exemplary dashboard showing a graph of target and average durations over time.

FIG. 7 is a screenshot of an exemplary dashboard showing dwell times at different locations at different times of day in bar chart form.

FIG. 8 is a flowchart of an exemplary embodiment of a method of monitoring a drive-through service.

### DETAILED DESCRIPTION

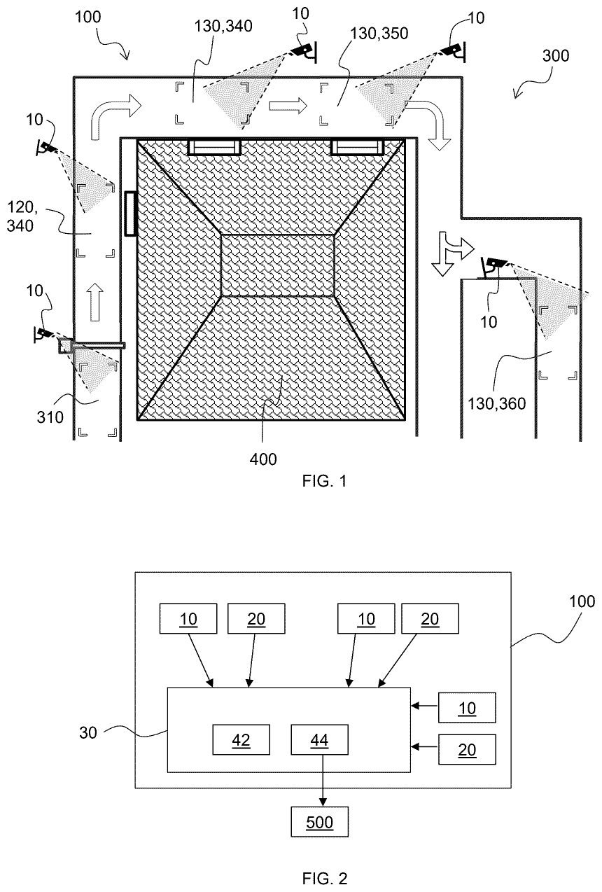

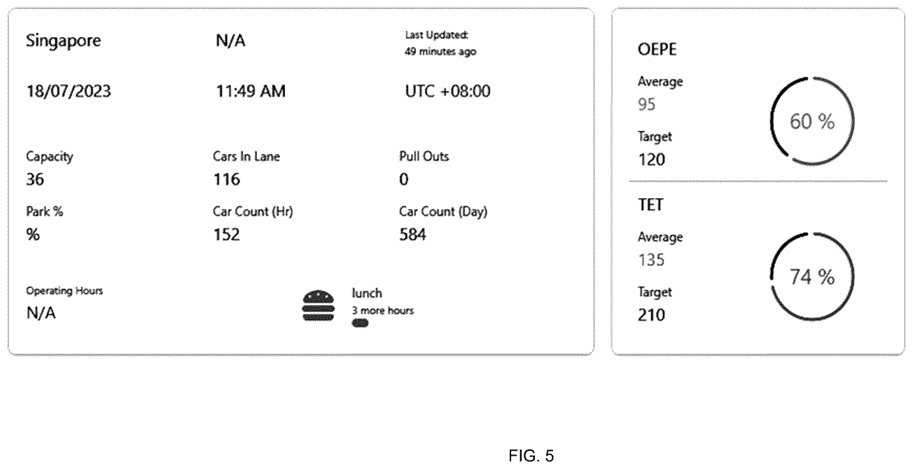

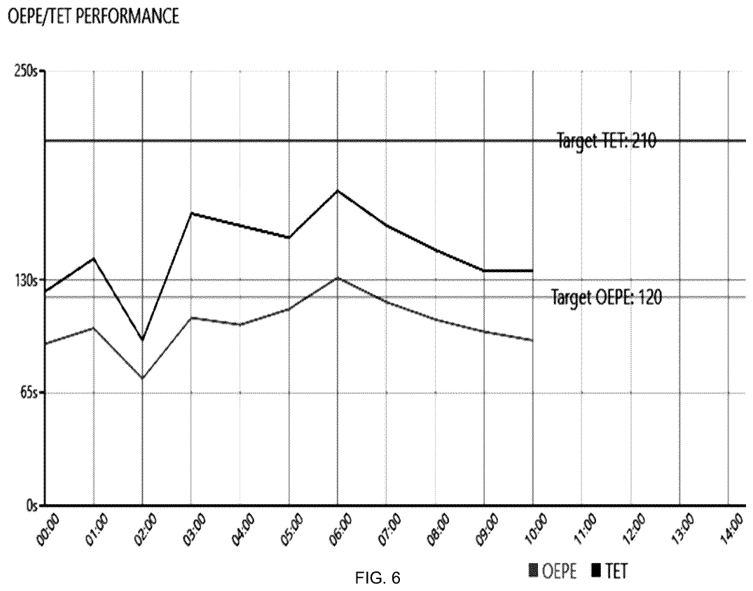

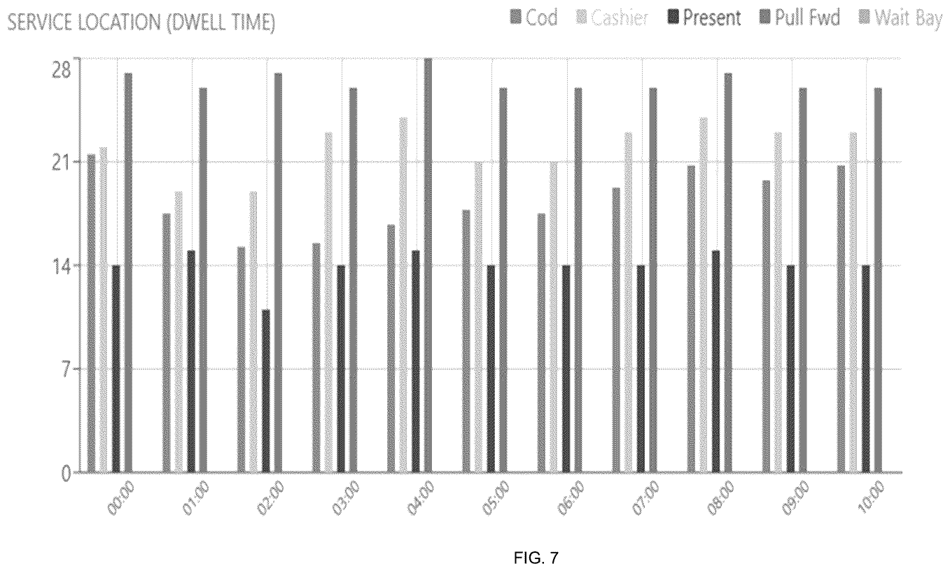

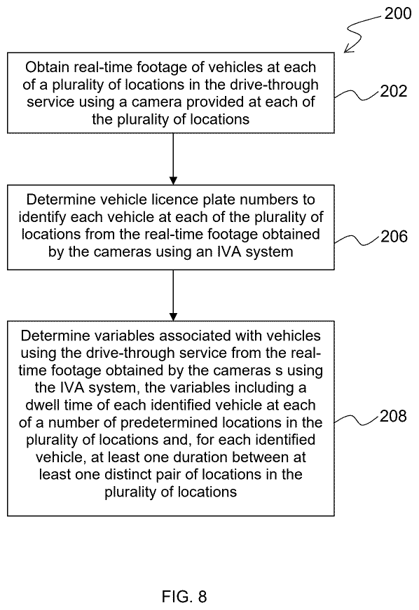

Exemplary embodiments of the drive-through service monitoring system 100 and method of monitoring a drive-through service 200 will be described with reference to FIGS. 1 to 8 in which the same reference numerals are used across the figures to refer to the same or similar parts.

In an exemplary embodiment, as shown in FIG. 1, the drive-through service monitoring system 100 may be deployed for a drive-through service 300 of an establishment 400 such as a quick service restaurant and the like. FIG. 2 shows a schematic exemplary architectural diagram of the drive-through service monitoring system 100 which comprises a plurality of cameras 10. A camera 10 is provided at each of a plurality of locations in the drive-through service 300 to obtain real-time footage of vehicles (not shown) at each of the plurality of locations. Each camera 10 may be a closed-circuit television (CCTV) camera, or an internet protocol (IP) camera or any other appropriate camera that can capture videos of service crew, vehicles, and licence plates of vehicles using the drive-through service 300. The cameras 10 continuously capture footage of vehicles in real-time as they progress through the drive-through service 300.

The plurality of locations in the drive-through service 300 typically include at least an ordering point 120 where customers place their orders, and one or more collection points 130 where ordered items can be received. The collection point 130 is usually also considered an end location from the point of view of a customer's experience when using the drive-through service 300, the collection point 130 typically being the location from which the customer will depart the drive-through service 300 after collecting the ordered items.

In some embodiments of the drive-through service 300, the ordering point 120 may also be a payment point 340. In such embodiments, after placing an order at the ordering point 120, payment may be made electronically using a payment machine installed at the ordering point 120. For example, the payment machine may be a payment card reader mounted on a speaker post at the ordering point 120. After making payment, the customer moves the vehicle to the collection point 130 to collect the ordered items.

In other embodiments of the drive-through service 300, the collection point 130 may also serve as the payment point 340. In such embodiments, after placing an order at the ordering point 120, the customer moves the vehicle to the collection and payment point 130, 340 to make payment. After making payment, the customer continues to wait in the vehicle at the collection and payment point 130, 340 for the ordered items. After collecting the items at the collection and payment point 130, 340, the customer leaves the drive-through service 300 from the collection and payment point 130, 340.

In further embodiments of the drive-through service 300, the payment point 340 may be separately provided before the collection point 130. In such embodiments, after placing an order at the ordering point 120, the customer moves the vehicle to the payment point 340 to make payment. After making payment, the customer moves the vehicle to the collection 130 point to collect the ordered items before leaving the drive-through service 300. In such embodiments, the plurality of locations may optionally include a pick-up or pull forward area 350 provided after the payment point 340. The plurality of locations may even further optionally include a waiting bay 360 provided after the pull forward area 350. In these embodiments, the collection point 130 at which the vehicle is stopped to wait for the ordered items may thus also be the pull forward area 350 or the waiting bay 360, depending on the configuration of the drive-through service 300. In use, after making payment at the payment point 340, if asked to do so, the customer may move the vehicle from the payment point 340 to the pull forward area 350 where the vehicle is stopped to wait for the ordered items before leaving the drive-through service 300 from the pull forward area 350. In some situations, if asked to do so, the customer may further move the vehicle from the pull forward area 350 to the waiting bay 360 where the vehicle is stopped to wait for the ordered items before leaving the drive-through service 300 from the waiting bay 360.

Although not shown in FIG. 1, it will be understood that the drive-through service 300 may have multiple ordering points, multiple payment points, multiple pull forward areas and/or multiple waiting bays as may be desired, with cameras 10 provided at these locations to identify and detect arrivals and departures of vehicles accordingly. Appreciably, the collection point 130 may be at any one of the payment point 340, pull forward area 350 or waiting bay 360, depending on the configuration of the drive-through service 300.

In the drive-through service 300, an ultrasonic sensor 20 as shown in FIG. 2 may also be provided at each of the plurality of locations that requires establishment of remote communication (i.e. non-face-to-face) between a customer at the location and a service crew member who is located elsewhere in the drive-through service 300. For example, a location where an ultrasonic sensor may be provided is the ordering point 120 where orders may be placed via a voice communication system by a customer speaking with a service crew member. Another location where an ultrasonic sensor may be provided is the payment point 340 where a customer may be asked by a service crew member to move the vehicle forward to a pick-up or pull forward area 350. The ultrasonic sensor at each of these locations is provided to detect arrival of a vehicle at the location and consequently automatically activate a voice communication system so that the customer at the location and the service crew member at another location can immediately talk to each other without having to manually activate the voice communication system.

The drive-through service monitoring system 100 further comprises an intelligent video analytics (IVA) system 30 as shown in FIG. 2 that harnesses the power of artificial intelligence and computer vision to extract valuable insights from the footage obtained the cameras 10, offering real-time analytics, visualization, and surveillance capabilities. In particular, the IVA system 30 is configured to determine vehicle licence plate numbers to identify each vehicle at each of the plurality of locations in the drive-through service 300. To do this, the IVA system 30 is provided with licence plate recognition (LPR) capability 42. The IVA system 30 may also be configured to identify different types of vehicles (e.g. cars, trucks or motorcycles) that use the drive-through service 300. In this way, each vehicle that uses the drive-through service 300 is identified and tracked by the IVA system 30, allowing precise monitoring of each vehicle's journey from entry to exit of the drive-through service 300. Additionally, the IVA system 30 has the capability to detect and differentiate service crew members from other pedestrians, particularly at the waiting bay 360. This functionality allows for a detailed analysis of the interactions between the service crew and customer vehicles, ensuring efficient service delivery, optimizing operations and customer satisfaction, as will be explained in greater detail below.

To assist the IVA system 30 in situations where license plate recognition (LPR) does not work because the vehicle license plate happens to be obscured in the real-time camera footage, the IVA system 30 may also incorporate customized tracking logic to ensure accurate tracking of vehicles, regardless whether they are moving forward or in reverse during their drive-through journey. For example, the tracking logic may be configured such that where a second location immediately succeeds a first location in a forward direction along the drive-through service 300, a vehicle that is first to leave a field of view of a first camera 10 at the first location in the forward direction must be the same vehicle that is the first to enter a field of view of a second camera 10 at the second location in the first direction. The tracking logic may also be configured to work the same way in a reverse direction, such that a vehicle that is first to leave a field of view of the second camera 10 at the second location in the reverse direction must be the same vehicle that is the first to enter a field of view of the first camera 10 at the first location in the reverse direction. In this way, the IVA system 30 is also able to track any vehicles moving in the reverse direction. The IVA system 30 is preferably integrated with source code of the cameras 10 so as to be able to obtain footage in real-time from all the cameras 10 without any delays. In this way, by integrating real-time footage from multiple cameras 10 strategically positioned at the plurality of locations throughout the drive-through service 300 and applying LPR as well as customized tracking logic, the IVA system 30 can seamlessly track each and every vehicle from entry to exit, in both the forward and reverse directions, while allowing staff to optimize throughput and minimize wait times for customers.

Besides identifying and tracking vehicles, the IVA system 30 is also configured to determine variables associated with vehicles using the drive-through service 300 from the footage obtained the cameras 10. Appreciably, the variables may be determined for specific times (e.g. during the day or week), or over specific time periods, or for a specified number of vehicles, and so on, thus obtaining information on usage and operations of the drive-through service 300.

One such variable that is determined by the IVA system 30 is a dwell time of each identified vehicle at each of a number of predetermined locations in the plurality of locations of the drive-through service 300. For example, the predetermined locations where dwell times are determined may include the ordering point 120, the payment point 340, the pull forward area 350 and/or the waiting bay 360. In this way, the monitoring system 100 is able to determine how long every identified vehicle spends at each of the predetermined locations. The IVA system 30 is preferably further configured to determine another variable such as an average dwell time at each of the predetermined locations from the dwell times determined for multiple identified vehicles at each of the predetermined locations at specific times. Tracking average dwell times at different times of the day or week can help management adjust staffing schedules to meet demand at peak periods, ensuring optimal service levels and customer satisfaction.

Besides dwell times, another variable determined by the IVA system 30 is the duration of various stages of progress through the drive-through service 300. The duration for a distinct stage is the time spent by a vehicle between a distinct pair of locations in the plurality of locations for each identified vehicle. Each distinct pair of locations comprises a first location and a second location. For example, a first distinct pair of locations may comprise an entry 310 of the drive-through service 300 as the first location and the collection point 130 as the second location. A second distinct pair of locations may comprise the ordering point 120 as the first location and the collection point 130 as the second location. Notably, the duration which is determined between pairs of locations could be any one of:
from arrival at the first location to arrival at the second location,
from arrival at the first location to departure from the second location,
from departure from the first location to arrival at the second location, and
from departure from the first location to departure from the second location.

In this way, it is possible to determine various durations such as: total experience time (TET), which is from arrival of an identified vehicle at the entry 310 to its departure from the collection point 130; and ordering completion to pick up and exit time (OEPE), which is from departure from the ordering point 120 to departure from the collection point 130. Another variable that is preferably also determined by the IVA system 30 is the average durations from the duration between distinct pairs of locations as determined for multiple identified vehicles. In practice, by analysing the time taken for vehicles to place their orders at the ordering point 120, reach the collection point 130, and complete the transaction, the system can identify bottlenecks and inefficiencies in the drive-through service 300.

As mentioned above, the IVA system 30 has the capability to detect and differentiate service crew from other pedestrians, particularly at the waiting bay 360. The purpose of this is to be able to determine the specific time when ordered items are received by an identified vehicle at the wait bay 360 from a service crew member. This is needed in order to be able to accurately determine the time-to-collection at the wait bay 360, which is the amount of time spent by the identified vehicle at the wait bay 360 waiting for collection of items. Accurate determination of the time to collection at the wait bay 360 is achieved by counting only the duration between the specific time when the identified vehicle is moved to the wait bay 360 and the specific time when ordered items are received by the identified vehicle at the wait bay 360 from a service crew member, and not counting any further time after collecting the ordered items that the identified vehicle may spend lingering at the wait bay 360 (e.g. for the customer to consume the collected items).

In addition to dwell times at predetermined locations and durations between pairs of locations, the IVA system 30 may also be further configured to determine other variables associated with vehicles using the drive-through service 300. Such variables may include: a number of vehicles (car count) moved to the pull forward area, a specific time when an identified vehicle is moved to the wait bay, a specific time when ordered items are received by vehicles at the wait bay from service crew, percentage of vehicles moved to the wait bay, a number of vehicles in the drive-through service between the entry and a final collection point (e.g. the wait bay 360 if one is provided) and/or a number of vehicles exiting the drive-through service before reaching the ordering point. Thus, the monitoring system 100 is able to accurately monitor the length of the drive-through queue in real-time.

The IVA system 30 may further be configured to trigger an alert when a preselected variable is determined to cross a preset threshold. For example, if the IVA system 30 determines a prolonged dwell time at a collection point 130, it can automatically trigger an alert to notify staff members to expedite order preparation and minimize customer wait times.

The IVA system 30 preferably further comprises a data visualization module 44 configured to present information from the determined variables associated with vehicles using the drive-through service 300 for performance monitoring of the drive-through service 300. Such variables may include the determined average dwell times and the determined average durations for various predetermined locations and pairs of locations. Using advanced data visualization techniques, information obtained from the determined variables is automatically converted into interactive pie charts, bar charts, and line charts that are presented on a dashboard displayed on an electronic visual display 500 such as the monitor of a computer or a screen of an electronic device (as shown in FIG. 2). Triggered alerts may also be presented on the dashboard, for example as flashing icons. The dashboard thus provides users of the drive-through service monitoring system 100 with real-time clear insights and allows operators to easily interpret trends, identify patterns, and make informed decisions to improve operational efficiency. For example, the presented information on the dashboard can be used to optimize staffing levels, streamline operations, and reduce wait times for customers. In this way, the drive-through service monitoring system 100 helps the establishment 400 identify areas for improvement and implement targeted interventions to enhance the overall customer experience.

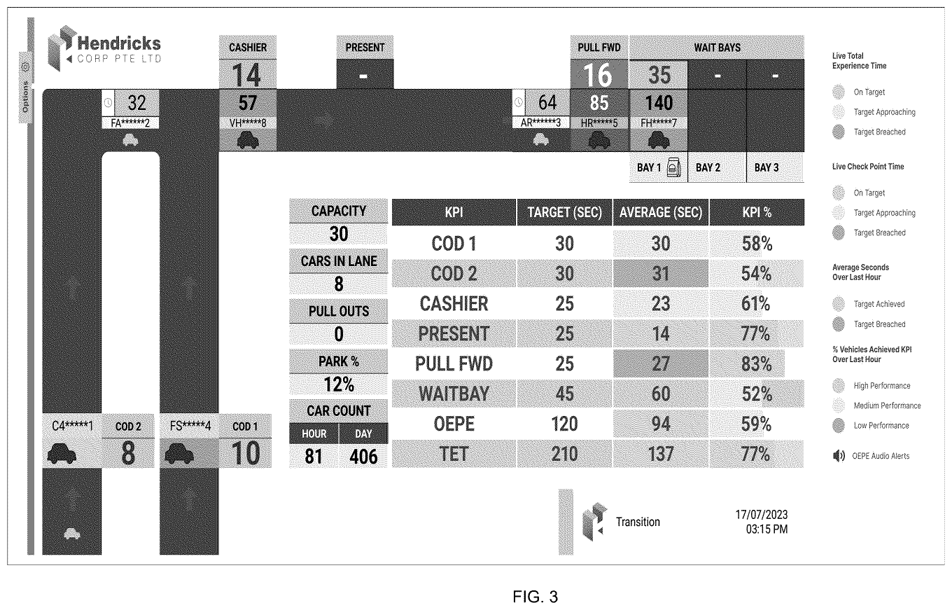

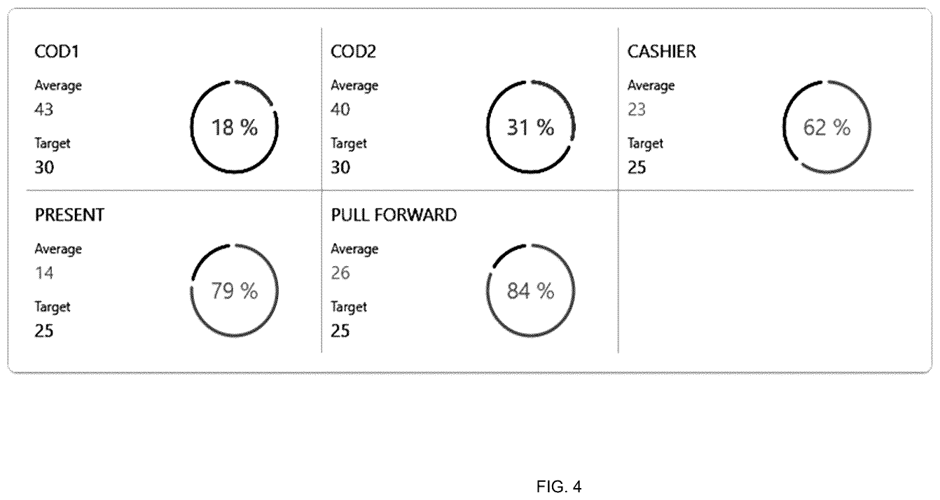

FIG. 3 is a screenshot of an exemplary dashboard presented by the data visualization module 44. In FIG. 3, determined variables are shown in table form, where COD1 and COD2 refer to two different ordering points 120, CASHIER refers to the payment point 340, and PRESENT refers to a further collection point 130 apart from the pull forward area 350 (PULL FWD) and the waiting bay 360 (WAITBAY). The abbreviations OEPE and TET have been explained above. FIGS. 4 to 6 depict further screenshots of other exemplary dashboard presentations that show the determined variables in other data visualisation forms. As can be seen in FIGS. 3-6, target average dwell times and target average durations may also be displayed on the dashboard. Such targets may be input by the establishment 400 according to what it considers is acceptable for customers using the drive-through service 300. In this way, a user of the monitoring system 100 can know by looking at the dashboard whether vehicles are spending more time than is considered acceptable at each predetermined location.

Using the IVA system 30, the drive-through service monitoring system 100 leverages data analysis in real-time, providing valuable insights and enabling data-driven decision-making. The presented data visualisations could comprise real-time and/or historical data, allowing users of the drive-through service monitoring system 100 to optimize operations of the drive-through service 300 and enhance efficiency. This allows the establishment 400 to improve its operations to enhance overall customer experience and increase sales, by providing reduced wait times, real-time alerts, and even personalized recommendations as the IVA system 30 can be configured to track repeat customers by associating their previously ordered items with their vehicle identity and using such information to suggest items that they may wish to order the next time they use the drive-through service 300.

Compared to conventional drive-through services 300 that use magnetic loops for vehicle detection, the presently disclosed drive-through service monitoring system 100 uses cameras 10 and LPR 42 capability together with intelligent video analytics to detect vehicles, service crew and track their movements more precisely and reliably. The IVA system 30 can also analyze historical data to identify peak hours and periods of high traffic volume. By visualizing this information through intuitive charts and graphs via the data visualization module 44, managers can adjust staffing levels and allocate resources more effectively to ensure smooth operations and timely order fulfillment during busy periods, including more accurate order taking, better traffic management, and reduced errors in service.

Advantageously, unlike magnetic loop systems, installation of the present monitoring system 100 requires no construction downtown to the drive-through service 300 or the establishment 400, ensuring continuous operation and uninterrupted service to customers. The camera-based monitoring system 100 is also much more easily scaled and adapted to changing needs of the establishment 400 compared to magnetic loop systems, as cameras 10 and/or ultrasonic sensors can be easily added or repositioned to accommodate fluctuations in traffic volume, changes in layout and/or establishment upgrades.

While there has been described in the foregoing description exemplary embodiments of the present invention, it will be understood by those skilled in the technology concerned that many variations in details of design, construction and/or operation may be made without departing from the present invention. It will be appreciated that many further alterations, modifications and permutations of various aspects of the described embodiments are possible that fall within the spirit and scope of the claims.

1. A drive-through service monitoring system comprising:
a camera provided at each of a plurality of locations in a drive-through service to obtain real-time footage of vehicles at each of the plurality of locations; and
an intelligent video analytics (IVA) system provided and configured to determine, from the real-time footage obtained by the cameras:
vehicle licence plate numbers to identify each vehicle at each of the plurality of locations, and
variables associated with vehicles using the drive-through service, wherein the variables include:
a dwell time of each identified vehicle at each of a number of predetermined locations in the plurality of locations; and
for each identified vehicle, at least one duration between at least one distinct pair of locations in the plurality of locations.

2. The drive-through service monitoring system of claim 1, wherein each distinct pair of locations comprises a first location and a second location, and wherein the duration is at least one of: from arrival at the first location to arrival at the second location, from arrival at the first location to departure from the second location, from departure from the first location to arrival at the second location, and from departure from the first location to departure from the second location.

3. The drive-through service monitoring system of claim 1, wherein the plurality of locations include an ordering point where customers place their orders and a collection point where ordered items are received; and wherein the predetermined locations include at least one of: the ordering point and the collection point.

4. The drive-through service monitoring system of claim 3, wherein the collection point is at least one of: a payment point where payment is made for an order placed at the ordering point, a pull forward area provided after the payment point, and a wait bay provided after the pull forward area.

5. The drive-through service monitoring system of claim 4, wherein the variables further include at least one of: a specific time when an identified vehicle is moved to the wait bay, percentage of vehicles moved to the wait bay, a number of vehicles in the drive-through service between the entry and a final collection point, and a number of vehicles exiting the drive-through service before reaching the ordering point.

6. The drive-through service monitoring system of claim 4, wherein the IVA system is further configured to determine, from the real-time footage obtained by the cameras, whether a person appearing in the real-time footage is a service crew member of the drive-through service, and wherein the variables further include: a specific time when ordered items are received by an identified vehicle at the wait bay from a service crew member, and a duration between the specific time when the identified vehicle is moved to the wait bay and the specific time when the ordered items are received by the identified vehicle at the wait bay from the service crew member.

7. The drive-through service monitoring system of claim 1, wherein the variables further include an average dwell time from the dwell times determined for multiple identified vehicles at each of the predetermined locations, and average durations from the durations determined between distinct pairs of locations for the multiple identified vehicles.

8. The drive-through service monitoring system of claim 3 when dependent on claim 2, wherein for each distinct pair of locations, the second location is the collection point and the first location is one of: the ordering point and an entry of the drive-through service.

9. The drive-through service monitoring system of claim 1, wherein the IVA system further comprises a data visualization module configured to present the determined variables and target variables on a dashboard displayed on an electronic visual display.

10. The drive-through service monitoring system of claim 1, wherein the IVA system is further configured to trigger an alert when a preselected variable is determined to cross a preset threshold.

11. The drive-through service monitoring system of claim 1, wherein an ultrasonic sensor is provided at each location in the drive-through service that requires establishment of remote communication between a customer at the location and a service crew member who is located elsewhere in the drive-through service to detect arrival of a vehicle at the location and consequently automatically activate a voice communication system provided at the location so that the customer and the service crew member located elsewhere can immediately talk to each other without having to manually activate the voice communication system.

12. A method of monitoring a drive-through service, the method comprising:
obtaining real-time footage of vehicles at each of a plurality of locations in the drive-through service using a camera provided at each of the plurality of locations; and
using an IVA system, from the real-time footage obtained by the cameras:
determining vehicle licence plate numbers to identify each vehicle at each of the plurality of locations, and
determining variables associated with vehicles using the drive-through service, wherein the variables include:
a dwell time of each identified vehicle at each of a number of predetermined locations in the plurality of locations; and
for each identified vehicle, at least one duration between at least one distinct pair of locations in the plurality of locations.

13. The method of claim 12, wherein each distinct pair of locations comprises a first location and a second location, and wherein the duration is at least one of: from arrival at the first location to arrival at the second location, from arrival at the first location to departure from the second location, from departure from the first location to arrival at the second location, and from departure from the first location to departure from the second location.

14. The method of claim 12, wherein the plurality of locations include an ordering point where customers place their orders and a collection point where ordered items are received; and wherein the predetermined locations include at least one of: the ordering point and the collection point.

15. The method of claim 14, wherein the collection point is one of: a payment point where payment is made for an order placed at the ordering point, a pull forward area provided after the payment point, and a waiting bay provided after the pull forward area.

16. The method of claim 15, further comprising, using the IVA system, from the real-time footage obtained by the cameras, determining at least one of: a specific time when an identified vehicle is moved to the wait bay, percentage of vehicles moved to the wait bay, a number of vehicles in the drive-through service between the entry and a final collection point, and a number of vehicles exiting the drive-through service before reaching the ordering point.

17. The method of claim 15, further comprising, using the IVA system, from the real-time footage obtained by the cameras, determining whether a person appearing in the real-time footage is a service crew member of the drive-through service, determining a specific time when ordered items are received by an identified vehicle at the wait bay from a service crew member, and determining a duration between the specific time when the identified vehicle is moved to the wait bay and the specific time when the ordered items are received by the identified vehicle at the wait bay from the service crew member.

18. The method of claim 12, wherein the variables further include an average dwell time from the dwell times determined for multiple identified vehicles at each of the predetermined locations over time, and average durations from the durations determined for the multiple identified vehicles between distinct pairs of locations.

19. The method of claim 14 when dependent on claim 13, wherein for each distinct pair of locations, the second location is the collection point and the first location is one of: the ordering point and an entry of the drive-through service.

20. The method of claim 12, further comprising a data visualization module of the IVA system presenting the determined variables and target variables on a dashboard displayed on an electronic visual display.

21. The method of claim 12, further comprising the IVA system triggering an alert when a preselected variable is determined to cross a preset threshold.

22. The method of 12, further comprising providing an ultrasonic sensor at each location in the drive-through service that requires establishment of remote communication between a customer at the location and a service crew member who is located elsewhere in the drive-through service, and, using the ultrasonic sensor, detecting arrival of a vehicle at the location and consequently automatically activating a voice communication system provided at the location so that the customer and the service crew member located elsewhere can immediately talk to each other without having to manually activate the voice communication system.
